(19) United States
(12) Patent Application Publication
(10) Pub. No.: US 2022/0349024 A1
(43) Pub. Date: Nov. 3, 2022

(54) PROCESSING GOLD-CONTAINING ORES

(71) Applicant: NEWCREST MINING LIMITED, Melbourne (AU)

(72) Inventor: John O'CALLAGHAN, Melbourne (AU)

(21) Appl. No.: 17/623,418

(22) PCT Filed: Jul. 2, 2020
(86) PCT No.: PCT/AU2020/050692

§ 371 Date: Dec. 28, 2021

(30) Foreign Application Priority Data
Jul. 5, 2019 (AU) 2019902382

(51) Int. Cl. C22B 11/08; C22B 11/02; C22B 3/04; C22B 3/02; C22B 1/06

(52) U.S. Cl. CPC C22B 11/08; C22B 11/02; C22B 3/04; C22B 3/02; C22B 1/06

(57) ABSTRACT

A method of processing a gold-containing ore that contains reactive sulphide minerals that includes selecting processing conditions to optimize liberating gold in reactive sulphide minerals and processing the ore in accordance with the selected processing conditions and liberating gold in the reactive sulphide minerals. In other words, when there are reactive sulphide minerals and “barren” minerals in an ore, the invention focuses on liberating gold in the reactive sulphide minerals only.

### TECHNICAL FIELD

The invention relates to processing gold-containing ores that contain reactive sulphide minerals.

The invention relates more particularly, although by no means exclusively, to recovering gold from gold-containing ores that contain reactive sulphide minerals and there is preferential deportment of gold to the reactive sulphide minerals.

### BACKGROUND ART

One known method for recovering gold from gold-containing sulphide minerals in ores includes:
(a) oxidizing sulphur in milled ores and/or flotation concentrates of milled ores under pressure oxidation conditions in an oxidation unit, such as an autoclave, and
(b) recovering gold from an output of the oxidation step.

Carbon-in-pulp is one but not the only known gold recovery option from oxidized ores.

The applicant has developed an improvement to the known method.

The above description is not an admission of the common general knowledge in Australia or elsewhere.

### SUMMARY OF THE DISCLOSURE

The applicant has realized that selecting processing conditions for gold-containing ores that are optimized to facilitate liberating gold only from reactive sulphide minerals in the ores is an effective option.

The term “reactive” sulphide minerals in an ore means sulphide minerals that react earlier than other sulphide minerals in the ore when heated under oxidizing conditions at a given temperature or react at lower temperatures than other minerals in the ore and have preferential deportment of gold in the minerals compared to the concentrations of gold in other less reactive sulphide minerals in the ore. The other less reactive sulphide minerals are described herein as “barren” minerals.

Examples of minerals that may be reactive sulphide minerals include iron-containing sulphide minerals, such as pyrite, arsenopyrite, chalcopyrite and all secondary copper sulphide minerals, pentlandite, and arsenian pyrite.

The reactive sulphide minerals may be reactive, by way of example only, as a consequence of distortion of the crystalline lattice, for example as a result of elements such as arsenic in the lattice.

The reactive sulphide minerals may be reactive for other reasons.

In situations where a method for recovering gold from gold-containing sulphide minerals in ores includes an oxidation step, such as a pressure oxidation step (or any other oxidation technology, such as but not limited to atmospheric tanks, bio-oxidation systems, heap leach systems, and nitric acid systems), the applicant has realized that it is not necessary to oxidize all of the sulphur in sulphide minerals in gold-containing ores to economically recover gold from the ores. Australian provisional application 2019900350 entitled “Processing Ores Containing Precious Metals” lodged on 5 Feb. 2019 in the name of the applicant and International application PCT/AU2020/050086 lodged on 5 Feb. 2020 in the name of the applicant describe an invention in this regard. The disclosure in the specifications of the provisional and International applications are incorporated herein.

The invention goes beyond the teaching of the provisional and International applications.

In particular, the applicant has realized that preferential deportment of gold to reactive sulphide minerals means that, where there are reactive sulphide minerals and “barren” minerals in an ore, it is sufficient to oxidize only the sulphur in reactive sulphide minerals and thereby liberate gold in the reactive sulphide minerals to obtain cost effective gold recovery and it is not necessary to oxidize sulphur in “barren” minerals.

In the context of the invention, where the method includes (a) an oxidation step and (b) a feed ore to the oxidation step has reactive sulphide minerals and “barren” minerals in the ore, the focus is on supplying sufficient oxygen within a reaction time period and subject to other processing conditions in an oxidation unit, such as an autoclave, to oxidize sulphur in reactive sulphide minerals only in the ore.

The invention has a beneficial impact on gold recovery steps on a discharge stream from the oxidation step.

In broad terms, the invention provides a method of processing a gold-containing ore that contains reactive sulphide minerals that includes selecting processing conditions to optimize liberating gold in reactive sulphide minerals and processing the ore in accordance with the selected processing conditions and liberating gold in the reactive sulphide minerals. In other words, in broad terms, when there are reactive sulphide minerals and “barren” minerals in an ore, the invention focuses on liberating gold in the reactive sulphide minerals only.

In addition, in broad terms, the invention provides a method of processing a gold-containing ore that contains reactive sulphide minerals, the method including:
(a) selecting processing conditions for a gold-containing ore to optimize liberating gold in reactive sulphide minerals, and
(b) processing the ore in accordance with the selected processing conditions and liberating gold in the reactive sulphide minerals.

Where there is a mixture of different sulphide minerals in an ore, typically, iron-containing sulphide minerals are more reactive than other sulphide minerals and contain higher concentrations of gold than less reactive sulphide minerals, i.e. “barren” minerals.

Iron-containing sulphide minerals may include by way of example any one or more than one of pyrite, arsenopyrite, chalcopyrite and all secondary copper sulphide minerals, pentlandite, and arsenian pyrite.

It is noted that not all iron-containing sulphide minerals are reactive sulphide minerals.

For example, at the Lihir mine of the applicant there are pyrites that are not reactive and have low concentrations of gold, typically 2-3 g/t of pyrite. There is also pyrite at Lihir that contains high concentrations of gold, typically 100-150 g/t of pyrite.

Where the method is a continuous method, step (a) may include assessing the effectiveness of actual processing conditions in processing step (b) at a given point in time and using this information to inform the selection of processing conditions for ore supplied to processing step (b) a later point in time.

In addition, or alternatively, where the method is a continuous method, step (a) may include assessing the proportion of the total sulphur that is in reactive sulphide minerals in the ore before the ore is supplied to processing step (b) to inform the selection of processing conditions for step (b).

The method may include periodically or continuously assessing the proportion of the total sulphur that is in reactive sulphide minerals in the ore, selecting processing conditions for step (b) to optimize processing the reactive sulphide minerals in the ore based on the assessments and, as required, varying the processing conditions in response to variations in selected processing conditions based on the ongoing assessments over time to continue to optimize processing of the reactive sulphide minerals.

The processing step (b) may include an oxidation step, such as a pressure oxidation step.

In that event, step (a) of the method may include selecting processing conditions for the oxidation step so that there is sufficient oxygen to oxidize at least substantially all of the sulphur in reactive sulphide minerals in the ore to liberate gold in the reactive sulphide minerals and not preferentially oxidize sulphur in “barren”, i.e. less reactive, sulphide minerals to thereby optimize processing of the reactive sulphide minerals.

It is noted that, in the method of the invention, it is not necessary to supply additional oxygen to the oxidation step or change other processing conditions to change oxidation because there is comparatively little value in oxidizing sulphur in “barren” minerals in the ore.

The applicant has found that complete oxidation of sulphur in reactive sulphide minerals is important because carry-over of reactive sulphide minerals in a discharge stream from the oxidation step to downstream processing steps, such as a downstream cyanide leach circuit, can interfere with gold recovery from the stream.

In one embodiment, the method may include:
(a) monitoring the oxidation-reduction potential (“ORP”) in a discharge stream from the oxidation step;
(b) using the ORP to determine the amount of oxygen and other processing conditions required to oxidize at least substantially all of the sulphur in the reactive sulphide minerals to optimize liberating gold in the reactive sulphide minerals in the oxidation step and not preferentially oxidize sulphur in “barren”, i.e. less reactive, sulphide minerals, and
(c) oxidizing the ore in the oxidation step as determined in step (b) and liberating gold in the reactive sulphide minerals.

The use of ORP is based on a realization that, if the ORP drops during the oxidation step, this can be a good indication whether the oxygen supplied to the step and the other process conditions (such as reaction time) are sufficient to oxidize all of the sulfur in the reactive sulphide minerals and there are no reactive sulphide minerals in the discharge stream from the step.

Depending on the ORP and other information on the mineralogy of the feed ore to the oxidation step, it is possible to determine the oxygen and other process requirements for processing the feed ore in the oxidation step.

It is noted that where there is a constant oxygen rate to an oxidation step and variation of oxidation is required based on ORP monitoring of the discharge stream, it is necessary to vary other processing conditions, such as ore feed rate to achieve complete oxidation of sulphur in reactive sulphide minerals in the oxidation step.

In another embodiment, the method may include:
(a) taking ore samples upstream of the oxidation step;
(b) assessing the proportion of the total sulphur in the ore samples that is in reactive sulphide minerals; and
(c) using the information from step (b) to determine the amount of oxygen and other processing conditions required to oxidize at least substantially all of the sulphur in the reactive sulphide minerals to optimize liberating gold in the reactive sulphide minerals in the oxidation step and not preferentially oxidize sulphur in “barren”, i.e. less reactive, sulphide minerals, and
(d) oxidizing the ore in the oxidation step as determined in step (c) and liberating gold in the reactive sulphide minerals.

The method may include periodically or continuously assessing the proportion of the total sulphur that is in reactive sulphide minerals in an ore feed to the oxidation step, selecting the amount of oxygen and other processing conditions in the oxidation step to oxidize at least substantially all of the sulphur in the reactive sulphide minerals and not preferentially oxidize sulphur in “barren” sulphide minerals based on the assessments and, as required, varying the processing conditions in the oxidation step in response to variations in selected processing conditions based on ongoing assessments over time to continue to optimize processing of the reactive sulphide minerals.

The processing step (b) may include a gold leaching step, such as a cyanide leach step, to recover gold from the oxidized ore or concentrates of the ore in a discharge stream from the processing step.

In a situation where processing step (b) includes an oxidation step, such as a pressure oxidation step, the adverse consequences of not adding enough oxygen to oxidize all of the reactive sulphide minerals are potentially substantial.

The adverse consequences apply to all oxidation technologies for reactive sulphide minerals, such as but not limited to autoclaves, atmospheric tanks, bio-oxidation systems, heap leach systems, and nitric acid systems. The invention is not limited to a particular oxidation technology.

The adverse consequences include by way of example:

1. As the reactive sulphide minerals such as pyrite contain the bulk of the gold, then not oxidizing all of the sulphur in the reactive sulphide minerals will lead to lower gold recovery. The amount of oxygen required to oxidize at least substantially all of the sulphur in the reactive sulphide minerals is a “tipping point” in terms of gold recovery vs oxidation for the gold-containing ores shown in FIG. 1 and is a key forward indicator for the ores. FIG. 1 is a graph of % recovery of gold from gold-containing sulphide ores versus the % oxidation of the minerals in the ores generated in pressure oxidation test work on a number of gold-containing ores. The curves in FIG. 1 include a slope of greater than 1:1 in a lower % oxidation section of the curve and a slope of less than 1:1 in a higher % oxidation section of the curve. The tipping point is the transition point between the two curves. FIG. 1 shows that at oxidation levels below the tipping point (generally identified by the numeral 7 in the Figure), there is a significant drop in recovery, indicating that sulphur in reactive sulphide minerals is not being fully oxidized at these oxidation values and some reactive sulphide minerals are being carried over to a cyanide leaching step (or other gold recovery step), where gold is typically not recovered efficiently from the reactive sulphide minerals. In other words, if the oxygen is less than that required to oxidize at least substantially all of the sulphur in the reactive sulphide minerals in an oxidation step, there will be carry-over of the sulphide minerals to downstream processing steps and a lower overall recovery because there is poor recovery from the unliberated gold in the carry-over reactive sulphide minerals. FIG. 1 is described further below.

2. The reactive sulphide minerals that are not oxidized or are only partly oxidized and therefore have at least some gold that has not been liberated in an oxidation step and are carried over to downstream processing steps may interfere with the downstream processing steps. For example, these carry-over reactive sulphide minerals will consume oxygen and cyanide in a cyanide leach step. The presence (with or without gold) of these carry-over reactive sulphide minerals will seriously reduce the extraction efficiency and should not be present in a cyanide leach step as they will reduce overall gold recovery for the liberated gold present. It is noted that the oxidation step may be carried out in equipment such as but not limited to autoclaves, atmospheric tanks, bio-oxidation systems, heap leach systems, and nitric acid systems.

The method may include processing an ore that has a recovery-oxidation curve in a graph of % recovery of gold versus % oxidation of the minerals that has a slope of less than 1:1 in a higher % oxidation part of the curve and a slope of greater than 1:1 in a lower % oxidation section of the curve in a processing plant, with the processing steps including:
(a) processing a mined ore in an ore preparation unit that includes, for example, comminution and size separation units, such as crushing and milling units, and producing an ore preparation unit output,
(b) selecting a target range of % oxidation values for sulphur in the ore in an oxidation unit to be in the higher oxidation section of the curve and less than complete oxidation of all of the sulphur in the ore and typically at or close to a tipping point between the two sections of the curve;
(c) also selecting the amount of oxygen and other processing conditions for the oxidation unit to oxidize at least substantially all of the sulphur in reactive sulphide minerals in the ore to liberate gold in the reactive sulphide minerals, with the amount of oxygen and other processing conditions being sufficient to oxidize sulphur in the reactive sulphide minerals only—because additional oxidation of sulphur is not necessary; and
(d) processing the ore in an oxidation unit in accordance with the selected processing conditions and oxidizing sulphur in reactive sulphide minerals and liberating gold in reactive sulphide minerals.

The method may include allowing variations of the amount of oxygen and other processing conditions in the oxidation unit over time.

The invention is not limited to a particular oxidation technology.

Different oxidation technologies, such as but not limited to autoclaves, atmospheric tanks, bio-oxidation systems, heap leach systems, and nitric acid systems, are all options.

The method may include recovering gold from a discharge stream from the oxidation unit.

The gold recovery step may be based on the use of any one or more than one of cyanide, halides (including chloride), thiosulphate to achieve gold recovery or any other means for final gold recovery, noting that oxidation step (d) is essentially a pre-treatment technology for gold recovery by any known method.

In broad terms, the invention also provides a processing plant for recovering gold from a gold-containing ore that contains reactive sulphide minerals, the plant including:
(a) a plurality of ore processing units;
(b) a control system for controlling at least one of the ore processing units to optimize processing reactive sulphide minerals in the ore to liberate gold in the reactive sulphide minerals in the unit.

In more particular terms, the invention also provides a processing plant for recovering gold from a gold-containing ore that contains reactive sulphide minerals, the plant including:
(a) an ore preparation unit that includes, for example, comminution and size separation units, such as crushing and milling units, for processing a mined ore and producing an ore preparation unit output from a mined ore,
(b) at least one oxidation unit, such as an autoclave unit, for oxidizing gold-containing sulphide minerals in the ore;
(c) a metal recovery unit for recovering gold from the oxidation unit output of at least one oxidation unit; and
(d) a control system for controlling the oxidation unit to oxidise at least substantially all of the sulphur in the reactive sulphide minerals in the ore and liberate gold in the reactive sulphide minerals and not preferentially oxidize sulphur in “barren”, i.e. less reactive, sulphide minerals in the ore to thereby optimize downstream recovery of gold from a discharge stream from the oxidation unit in the metal recovery unit.

Typically, the plant includes a sulphide concentration unit, such as a sulphide flotation unit, for producing a concentrate output from at least a part of the ore preparation unit output.

With this arrangement, the oxidation unit may be used for oxidizing sulphur in the concentrate output of the flotation unit.

In more particular terms, the invention also provides a processing plant for recovering gold from a gold-containing ore that contains reactive sulphide minerals, the plant including:

(a) an ore preparation unit that includes, for example, comminution and size separation units, such as crushing and milling units, for processing a mined ore and producing an ore preparation unit output from a mined ore,

(b) a sulphide concentration unit, such as a sulphide flotation unit, for producing a concentrate output from at least a part of the ore preparation unit output;

(c) at least one oxidation unit, such as an autoclave unit, for oxidizing sulphur in gold-containing sulphide minerals in the ore;

(d) a metal recovery unit for recovering gold from the oxidation unit output of at least one oxidation unit and/or concentrate output from the sulphide concentration unit; and

(e) a control system for controlling operation of one or both of the oxidation unit and the metal recovery unit, the control system being operable to control the operation of the oxidation unit and/or the metal recovery unit to optimize recovery of gold from the reactive sulphide minerals.

The invention is equally applicable to a greenfield plant and a brownfield plant.

### BRIEF DESCRIPTION OF THE DRAWINGS

The invention is described further below with reference to the accompanying drawings, of which:

FIG. 1 is a series of recovery-oxidation curves for several typical gold-containing sulphide ores in a graph of % recovery of gold from gold-containing sulphide minerals versus the % oxidation of the minerals;

FIG. 2 is a diagram of a gold processing plant for carrying out one embodiment of a plant and a method for recovering gold from an ore that contains gold-containing sulphide minerals in accordance with the invention;

FIG. 3 is a graph of IR intensity versus time generated in a LECO SC632 instrument that provides information on sulphur components in a test sample, with the graph being a modified from a standard graph produced by the LECO instrument;

FIG. 4 is a graph that illustrates a situation where the oxygen level supplied to autoclave units in the FIG. 2 plant is below that required to oxidize all of the reactive sulphide minerals in an ore sample;

FIG. 5 is a graph that illustrates a situation where the oxygen level supplied to autoclaves in the FIG. 2 plant is above that required to oxidize all of the reactive sulphide minerals in an ore sample; and

FIG. 6 is a graph of oxidation-reduction-potential of an autoclave discharge during a 20-hour time period of operation of an autoclave at the Lihir mine of the applicant.

### DESCRIPTION OF EMBODIMENTS

As described above, the invention provides a method of processing gold-containing ores that contain reactive sulphide minerals, with the method including:
(a) selecting processing conditions for the ore to optimize processing reactive sulphide minerals in the ore to liberate gold from reactive sulphide minerals; and
(b) processing the ore in accordance with the selected processing conditions and liberating gold from reactive sulphide minerals.

As noted above, the applicant has realized that selecting processing conditions for gold-containing ores that are optimized to facilitate liberating gold only from reactive sulphide minerals in the ores and not preferentially from “barren”, i.e. less reactive, sulphide minerals in the ores is an effective option.

The following description focuses on selecting processing conditions to optimize oxidizing reactive sulphide minerals in an ore in a pressure oxidation unit, such as a series of autoclaves, to liberate gold in the reactive sulphide minerals to facilitate recovering the gold in downstream processing unit operations, such as a carbon in pulp operation. It is noted that the invention is not confined to this application.

The following description focuses on reactive pyrite as the reactive sulphide mineral, noting that the invention is not confined to reactive pyrite and is applicable to other reactive sulphide minerals.

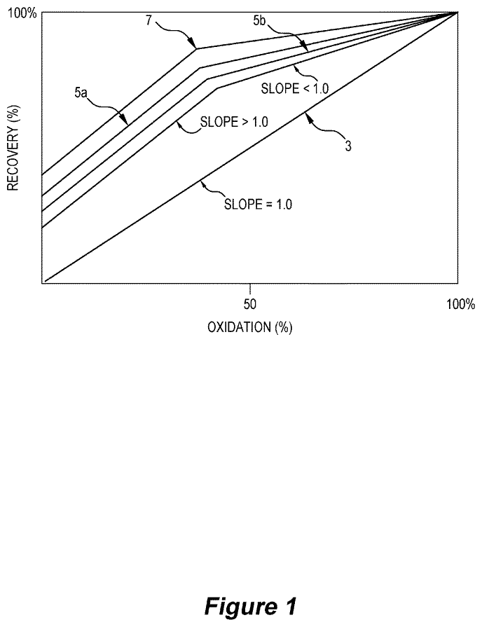

The following description also focuses on gold-containing minerals of the type illustrated in FIG. 1.

The graph of % recovery of gold from gold-containing sulphide ores versus the % oxidation of sulphur in the ores in FIG. 1 shows the recovery-oxidation curves for several typical gold-containing ores that contain a mixture of reactive pyrite and other less-reactive gold-containing minerals and are predominantly pyrite.

With reference to FIG. 1, the straight line identified by the numeral 3 in FIG. 1, which extends from the origin with a slope of 1:1 is a typical curve for a significant percentage of one group of known gold-containing sulphide ores in which there is a uniform dispersion of gold particles in fine pyrite particles. It is clear from the line 3 that changing the amount of oxidation of these ores has a significant effect on recovery. For example, decreasing the oxidation from 80% to 70% will result in a proportional decrease in the gold production rate. By way of further example, increasing the oxidation from 70% to 80% will result in a proportional increase in the gold production rate.

The curves shown in the section of the graph of FIG. 1 that is above the line 3 are typical curves for a significant percentage of another group of known gold-containing sulphide ores that contain reactive sulphide minerals and “barren” sulphide minerals. The curves have two sections, described by the numerals 5a and 5b.

The curve sections 5a are in a lower oxidation part of the Figure and have a slope of greater than or equal to 1:1. The curve sections 5b are in a higher oxidation part of the Figure and have a slope of less than 1:1.

The transition between the lower and higher curve sections 5a, 5b is typically approximately 45% oxidation for the curves shown in FIG. 1. However, this transition will vary depending on factors such as the ore type and gold grade. For example, the applicant is aware of ores that have transitions around 30% and lower than 30%. The transition can be higher, up to say 70% or 80%. The transition is described above as a “tipping point”.

It can be appreciated from the curves that changing the % oxidation of sulphur in the minerals in these ores in the higher curve sections 5b that have a slope of less than 1:1, i.e. above approximately 45% oxidation in FIG. 1, has a minimal effect on recovery because the curve sections 5b are nearly flat. For example, decreasing the oxidation from 80% to 70% will result in a minimal decrease in the gold recovery. It follows that there is a marginal advantage only in terms of sulphur oxidation and therefore gold liberation to operate at high oxidation levels. Significantly, the reduction in oxidation from 80% to 70% allows higher mass flowrates of ore because the lower oxidation makes it possible to operate with shorter residence times in the oxidation step. The slope of the curves provides flexibility with respect to plant operation. The flexibility is relevant when all of the plant equipment is operating properly. The flexibility is also relevant when there is a loss of equipment up-time.

It is noted that, reactive sulphide minerals, such as reactive pyrite, are being burnt across all oxidation values in the upper curve sections 5b shown in FIG. 1.

The slopes of the curves in sections 5b reflect the gold associated with the “barren”, i.e. less reactive pyrite and any other less reactive sulphide minerals.

Going from 60 to 80% oxidation along a selected upper curve section 5b means that, at both 60% and 80%, substantially all of the sulphur in the high-gold containing reactive pyrite has already been burnt and that going from 60 to 80% oxidation is burning “barren” pyrite for incremental gold recovery and loss of mass throughput due to increased residence time in oxidation units.

The tipping point between curve sections 5a, 5b is reached when substantially all of the sulphur in the reactive pyrite has been burnt.

One embodiment of the invention includes a control system that monitors the amount of oxidation of reactive pyrite and any other reactive sulphide minerals in ores upstream of oxidation units and controls operating conditions in the oxidation units to ensure that the amount of oxidation is above the tipping point for each ore. This ensures that the sulphur in at least substantially all of the reactive pyrite and any other reactive sulphide minerals has been oxidized and therefore gold in these minerals has been liberated.

The control system is described further below in the context of the embodiment of the of a plant and a method for recovering gold from an ore that contains gold-containing reactive and “barren”, i.e. less reactive, sulphide minerals.

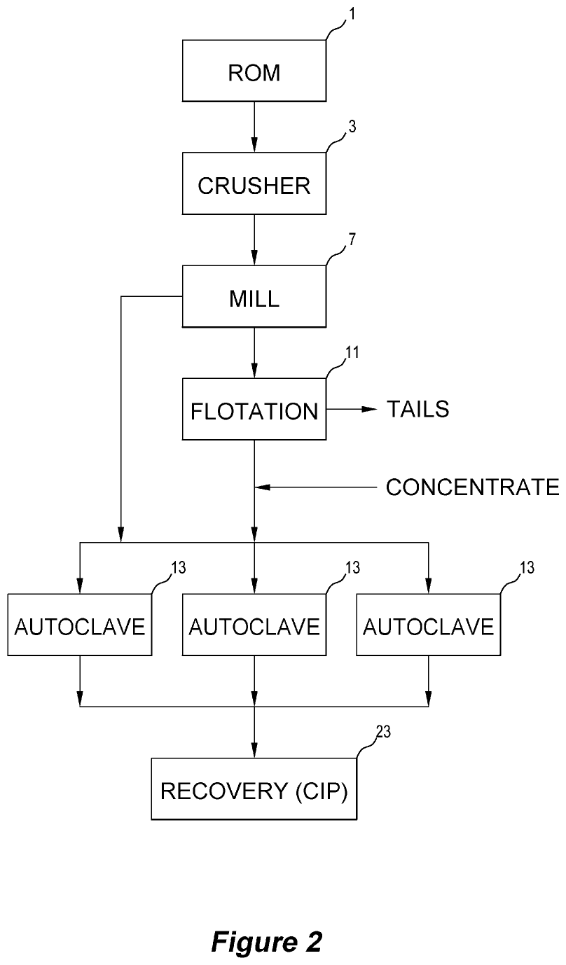

With reference to the flow sheet of FIG. 2, gold-bearing ore (ROM) 1 from a mine or a mine stockpile is subjected to ore preparation in an ore preparation unit, as follows.
The ore is subjected to a crushing stage, which in the described embodiment comprises primary crushing in a crusher unit 3, which may be a plurality of separate crusher units 3, for example gyratory crushers and jaw crushers and other types of crushing units. The invention extends to any suitable types of crushers.
The crushed ore produced in the crusher unit 3 may be stored in a coarse ore stock pile (not shown).
Coarse ore from the crushing stage and/or the coarse ore stock pile is supplied to a milling unit 7, typically including SAG and ball mills, but may be any other suitable mills, and produces a mill output. The mill output is in the form of slurries (typically having 40-60 wt. % solids) having any suitable particle size distribution.

The mill output from the milling unit 7 is split and supplied via separate transfer lines to a flotation unit 11 and to three autoclave units 13.

The split between the amount of ore preparation unit output transferred to the flotation unit 11 and the amount of ore preparation unit output transferred directly to the autoclave units 13 may vary depending on operational requirements, including the sulphur and other characteristics of feed ore to the units 11, 13.

The flotation unit 11 produces a concentrate slurry. The concentrate slurry is transferred via a transfer line to the autoclave units 13.

The flotation unit 11 also produces a tails slurry. This is transferred via a transfer line for downstream processing (not shown in the Figure).

The flotation unit 11 may be any suitable unit.

The autoclave units 13 operate under high pressure and high temperature, with oxygen being supplied to the units 13, to oxidize sulphur in the ore preparation unit output and sulphur in the concentrate slurry from the flotation unit 11 and produces an autoclave output slurry.

It is noted that the invention is not confined to the use of autoclave units and extends to any suitable oxidation units for oxidizing sulphur in the feed ore and concentrate slurry to the units. The sulphur oxidation liberates gold in the gold-containing minerals.

The autoclave output slurry is returned to atmospheric conditions. This is accomplished through one or two or more than two letdown/flash stages (not shown).

The autoclave output slurry is transferred to a metal recovery unit 23 for recovering gold. The metal recovery unit 23 may be any suitable unit. One example of a suitable gold-recovery operation is a carbon-in-pulp (CIP) process. Other examples include thiosulphate or glycine or chloride leaching processes.

The autoclave units 13 may be any suitable units operating at suitable elevated pressure and temperature conditions, with an oxygen plant (not shown) supplying an oxygen-containing gas, typically pure oxygen, to the autoclaves of the autoclave units 13 and a holding tank (not shown) that stores the concentrate slurry to be supplied to the autoclaves of the autoclave units 13.

By way of example, typical operating conditions in the autoclave units are as follows:
Elevated temperature—at least 200° C.
Elevated pressure—at least 2300 kPa gauge, typically at least 2500 kPa gauge.
95-100% O₂.
Exothermic.

The target oxidation conditions for the autoclave units 13 are selected to oxidize sulphur to a % oxidation value for the ore that is at or close to the tipping point 7 between the curve sections 5a, 5b in FIG. 1.

More particularly, the oxidation conditions in the autoclave units 13 are selected so that at least substantially all of the sulphur in reactive pyrite and any other reactive sulphide minerals in the ore is oxidized and sulphur in other minerals, i.e. “barren” minerals, is not preferentially oxidized.

In this context, the reference to “preferentially oxidized” herein is a recognition that there may be some oxidation of “barren” minerals, but that the conditions are such that this will not occur in preference to oxidation of reactive sulphide minerals.

The oxidation conditions, such as oxygen flow rate and residence time, may be a fixed or variable in each autoclave unit 13, and there may be differences in and variations of oxidation values in different autoclave units 13 depending on operational factors.

The method makes it possible to maximize ore sulphur mass feed rate to the autoclave units 13 at all times irrespective of equipment availability (upstream and downstream of the autoclave units 13) and ore type variability and without being dependent on a target sulphur % oxidation in each of the autoclave units 13. The reason for this is that the method is not dependent on operating to completely oxidize all of the sulphur in gold-containing minerals in the ore.

In the context of FIG. 2, the above-mentioned control system monitors the amount of oxidation of sulphur in reactive pyrite and any other reactive sulphide minerals in ores upstream of the oxidation units 13 and controls operating conditions in the oxidation units 13 to ensure that the amount of oxidation is at or above the tipping point 7 oxidation % for the particular ore being processed in the autoclave units 13—as shown in FIG. 1.

The control system includes:
(a) collecting ore samples upstream of the autoclave units 13;
(b) selecting the amount of oxygen for the autoclave units 13 to be sufficient to completely oxidize all of the sulphur in the reactive pyrite and other reactive sulphide minerals in the ore to liberate gold from the reactive sulphide minerals.

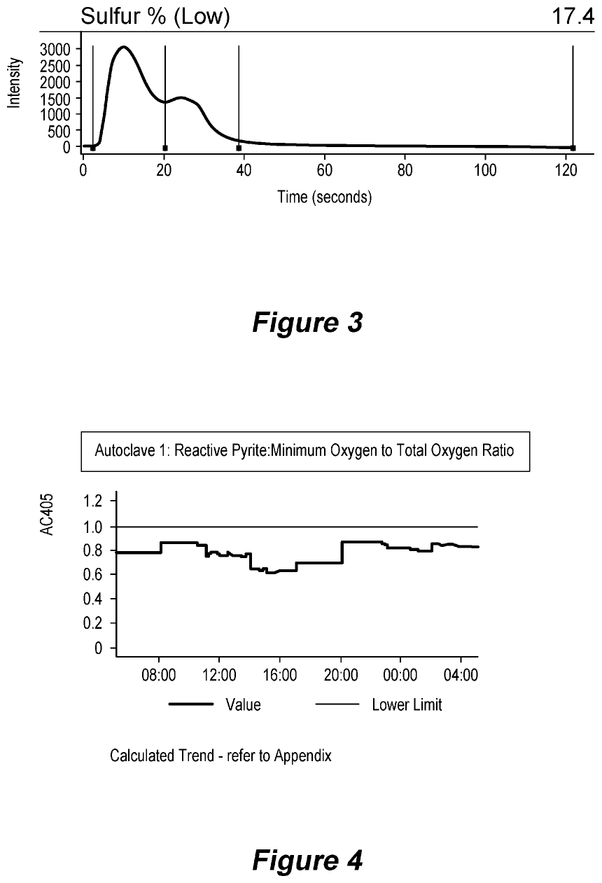

In one embodiment of the invention, described below in relation to FIGS. 3-5, in order to determine the amount of oxygen and other processing conditions required in item (b) above the applicant uses a modified LECO SC632 instrument to generate data on the proportion of the total sulphur in the ore samples that is in reactive pyrite and other reactive sulphide minerals in the ore samples.

In another embodiment of the invention, described below in relation to FIG. 6, in order to determine the amount of oxygen and other processing conditions required in item (b) above, the applicant monitors the ORP in the slurry output of the autoclave units 13.

FIGS. 3-5 Embodiment

The conventional LECO SC632 instrument produces data on Total S and Total C in test samples. The LECO SC632 instrument heats samples to a constant temperature and analyses the decomposition of the samples over time. In the case of S, the LECO SC632 instrument monitors the decomposition of sulphur compounds in the samples, noting that different sulphur compounds decompose at different temperatures or at different times when heating is at a constant temperature. The LECO SC632 instrument uses IR detectors to produce IR intensity data over time. The intensity data is a measure of the sulphur compounds. The standard LECO SC632 instrument produces a visual display in the form of a graph of intensity versus time for sulphur (and another graph for C).

The applicant realized that the standard graph can be used as a basis to provide valuable information on the amount of reactive sulphide minerals in ore for use for controlling autoclave operation.

LECO was retained by the applicant to modify the software of the standard LECO SC632 instrument to include an algorithm of the applicant and to produce a new graph that provides information on the sulphur (and C) species in ores.

FIG. 3 is an example of the new graph for one sample.

The peaks and troughs within the graph of FIG. 3 indicate the presence of faster and slower reactive sulphide minerals. The graph provides reliable and rapid sulphide sulfur values. The information derived from the graph includes a “sulphide reactivity index” that can be used to characterize autoclave feed ores by differentiating between more reactive sulphide minerals and less reactive sulphide minerals. The following dot points summarise relevant technical points.
Reactivity of sulphide minerals is different in different ores.
Sulphur is a measure of reactivity of sulphide minerals.
Reactivity is linked to recovery.
Low reactivity means low sulphur oxidation and therefore low heat generation.
High reactivity means high sulphur oxidation and therefore high heat generation.
The sulphide reactivity index—an expression of amounts of more reactive sulphide minerals and less reactive sulphide minerals.

The sulphide reactivity index is a control parameter for the Lihir autoclaves.

Understanding the amounts of more reactive sulphide minerals and “barren”, i.e. less reactive sulphide, minerals makes it possible to optimize oxygen supply and this is beneficial for autoclave costs and downstream cyanide consumption.

It is noted that determination of reactive sulphide minerals can also have direct benefits in non-oxidation processes, e.g. where ores (and concentrates of ores) containing different sulphide species. Specifically, determining the amounts of reactive sulphide sulphur can be used to predict plant performance and allow prior adjustment of operating parameters to optimize economic gold recovery.

As noted above, FIG. 3 shows a modified form of a standard LECO SC632 instrument analysis graph produced in a typical sample analysis by the LECO instrument.

The graph of FIG. 3 is marked-up with vertical lines that indicate the boundaries between reactive sulphide minerals, less sulphide minerals, and sulphate sulphur.

The region of the graph between the 1^{st} and 2^{nd} vertical lines from the left hand side of the graph indicates reactive sulphide minerals, the region between the 2^{nd} and 3^{rd} vertical lines indicates less sulphide minerals, and the area to the right of the 3^{rd} vertical line indicates sulphate sulphur. The thermal decomposition of these three forms of sulphide/sulphate mineral overlap to an extent on the X axis and, hence, the absence of clearly defined separate peaks. The location of the boundaries was determined having regard to analysis of pure specimen samples of different sulphide and sulphate minerals and interpretation by the applicant.

Calculating the areas within the three regions defined by the boundaries provides an indication of the amount of reactive sulphide minerals in the ore as a proportion of the total sulphur in the sample.

The applicant has found that the modified LECO SC632 instrument can generate data on the sulphide reactivity index for ore samples sufficiently quickly for the information to be considered and taken into account by autoclave operators to make adjustments to operative conditions in the autoclaves.

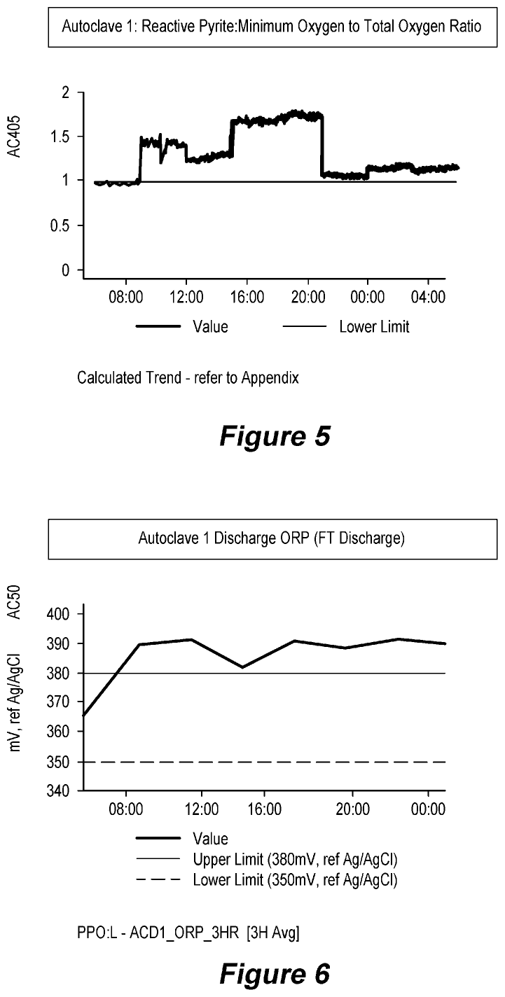

FIGS. 4 and 5 show the results of operational data for autoclave units 13 at one of the mines of the applicant.

Each Figure plots the amount of oxygen supplied to the autoclave units 13 versus time, with the oxygen expressed as a ratio of the amount of oxygen supplied and the amount of oxygen required to oxidize all of the sulphur in the reactive pyrite and other reactive pyrites in the ore in the autoclave units 13.

The straight line at a value of 1 in each Figure indicates 100% oxidation of reactive sulphide minerals versus time, based on information generated by the modified LECO SC632 instrument on ore samples collected upstream of the autoclaves.

It is evident from FIG. 4 that for the time period covered by the graph, the amount of oxygen supplied to the autoclave units 13 was typically 20% below that required to completely oxidize the reactive sulphide minerals in the ore being processed in the autoclave units 13.

Therefore, typically 20% of the reactive sulphide minerals were carried over to the metal recovery unit 23, with a resultant loss of recovery and increased use of reagents to compensate for reagent consumption for the reactive sulphide minerals.

The information in FIG. 4 provides autoclave operators (and operators of other oxidation technologies) with an opportunity to make adjustments to autoclave operating conditions, for example oxygen flow rates and/or autoclave residence time, to increase oxidation of reactive sulphide minerals.

It is evident from FIG. 5 that for the time period covered by the graph, the amount of oxygen supplied to the autoclave units 13 was equal to or above that required to completely oxidize the reactive sulphide minerals in the ore being processed in the autoclave units 13.

Therefore, the processing conditions in FIG. 5 ensured that all of the sulphur in the reactive sulphide minerals in the ore in the autoclave units 13 at that time were oxidized, thereby optimizing gold liberation and subsequent gold recovery in the metal recovery unit 23.

It is evident from FIG. 5 that the autoclave units 13 are oxidizing all of the reactive sulphide minerals.

FIG. 6 Embodiment

The embodiment shown in FIG. 6 relates to a different approach to that illustrated in relation to FIGS. 3 to 5 for selecting the amount of oxygen and other processing conditions for the autoclave units 13 to be sufficient to completely oxidize reactive sulphide minerals in the ore to liberate gold from reactive sulphide minerals.

FIG. 6 is a graph of oxidation-reduction-potential of a discharge stream from an autoclave during a 20-hour time period of operation of an autoclave at the Lihir mine of the applicant.

It is possible to infer the amount of reactive pyrite and other reactive sulphide minerals remaining in the discharge stream from the ORP data shown in the graph.

Lower ORP values indicate higher amounts of non-oxidized reactive pyrite.

More particularly, If the ORP values are low, this shows that reactive pyrite is still present and has not been burnt, and the autoclave operators must slow down the throughput in a situation where the oxygen rate is constant in order to ensure complete oxidation of the sulphur in reactive pyrite and other reactive sulphide minerals only.

With reference to FIG. 6, maximum sulphur mass throughput into the autoclave with sulphur in all of the reactive pyrite being burnt and no oxidation of sulphur in barren sulphide minerals resulted in ORP values in the range of 350-380 mV (Ag—AgCl ref).

The ORP values at the end of the monitored period were >380 mV, indicating an opportunity to increase the sulphur mass throughput for the autoclave (in a situation where the autoclave operates with a constant oxygen rate) for similar feed ore.

It follows from the above that the ORP data, together with information on the mineralogy of incoming feed ore, makes it possible to make adjustments, if required, to the oxygen rate (if this is variable) and/or other autoclave processing conditions to achieve complete oxidation of sulphur in reactive sulphide minerals in the feed ore and not oxidize sulphur in barren sulphide minerals, with the beneficial impact on cost effective gold recovery in downstream processing steps.

By way of summary:
1. Reactive sulphide minerals measurement allows optimization of an oxidation step to liberate the gold in ores that is preferentially contained in the reactive sulphide minerals.
2. Reactive sulphide minerals measurement allows optimization of final gold recovery processes, such as carbon-in-pulp to optimize gold recovery, with the required reagent and other operating parameters being determined prior to ore/concentrate treatment. It is noted that optimization is not confined to gold in reactive sulphide minerals.

Many modifications may be made to the invention described above without departing from the spirit and scope of the invention.

1. A method of processing a gold-containing ore that contains reactive sulphide minerals, the method comprising:
(a) selecting processing conditions for a gold-containing ore to optimize liberating gold in reactive sulphide minerals, and
(b) processing the gold-containing ore in accordance with the selected processing conditions and liberating gold in the reactive sulphide minerals.

2. The method defined in claim 1, operating as a continuous method and wherein (a) includes assessing the effectiveness of actual processing conditions in (b) at a given point in time and using information obtained thereby to inform the selection of processing conditions for ore supplied to (b) at a later point in time.

3. The method defined in claim 1, operating as a continuous method and wherein (a) includes assessing the proportion of the total sulphur that is in reactive sulphide minerals in the ore before the ore is supplied to (b) to inform the selection of processing conditions for (b).

4. The method defined in claim 1, including:
periodically or continuously assessing a proportion of the total sulphur that is in reactive sulphide minerals in the ore;
selecting processing conditions for (b) to optimize processing of the reactive sulphide minerals in the ore based on the assessments; and
as required, varying the processing conditions in response to variations in selected processing conditions based on the ongoing assessments over time to continue to optimize processing of the reactive sulphide minerals.

5. The method defined in claim 1, wherein (b) includes an oxidation step.

6. The method defined in claim 5 wherein (a) includes selecting processing conditions for the oxidation step so that there is sufficient oxygen to oxidize all of the sulphur in reactive sulphide minerals in the ore to liberate gold in the reactive sulphide minerals to thereby optimize processing the reactive sulphide minerals.

7. The method defined in claim 5, further comprising:
(c) monitoring the oxidation-reduction potential (“ORP”) in a discharge stream from the oxidation step;
(d) using the ORP to determine the amount of oxygen and other processing conditions required to oxidize all of the sulphur in the reactive sulphide minerals to optimize liberating gold in the reactive sulphide minerals in the oxidation step and not preferentially oxidize sulphur in barren sulphide minerals, and
(e) oxidizing the ore in the oxidation step as determined in (d) and liberating gold in the reactive sulphide minerals.

8. The method defined in claim 5, further comprising:
(c) taking ore samples upstream of the oxidation step;
(d) assessing the proportion of the total sulphur in the ore samples that is in reactive sulphide minerals; and
(e) using the information from (d) to determine an amount of oxygen and other processing conditions required to oxidize all of the sulphur in the reactive sulphide minerals to optimize liberating gold in the reactive sulphide minerals in the oxidation step and not preferentially oxidize sulphur in barren sulphide minerals; and
(f) oxidizing the ore in the oxidation step as determined in (e) and liberating gold in the reactive sulphide minerals.

9. The method defined in claim 5, further comprising:
periodically or continuously assessing the proportion of the total sulphur that is in reactive sulphide minerals in an ore feed to the oxidation step;
selecting the amount of oxygen and other processing conditions in the oxidation step to oxidize all of the sulphur in the reactive sulphide minerals and not preferentially oxidize sulphur in other barren sulphide minerals based on the assessments; and
as required, varying the processing conditions in the oxidation step in response to variations in selected processing conditions based on ongoing assessments over time to continue to optimize processing of the reactive sulphide minerals.

10. The method defined in claim 1, wherein (b) includes a gold leaching step to recover gold from the oxidized ore or concentrates of the ore in a discharge stream from the processing step.

11. The method defined in claim 1, comprising:
processing an ore that has a recovery-oxidation curve in a graph of percent recovery of gold versus percent oxidation of the minerals that has a slope of less than 1:1 in a higher percent oxidation part of the curve and a slope of greater than 1:1 in a lower percent oxidation section of the curve in a processing plant, the processing steps comprising:
processing a mined ore in an ore preparation unit that includes comminution and size separation units, and producing an ore preparation unit output;
selecting a target range of percent oxidation values for sulphur in the ore in an oxidation unit to be in the higher oxidation section of the curve and less than complete oxidation of all of the sulphur in the ore; and
selecting an amount of oxygen and other processing conditions for the oxidation unit to oxidize all of the sulphur in reactive sulphide minerals in the ore to liberate gold in the reactive sulphide minerals, with the amount of oxygen and other processing conditions being sufficient to oxidize sulphur in the reactive sulphide minerals only; and
processing the ore in an oxidation unit in accordance with the selected processing conditions and oxidizing sulphur in reactive sulphide minerals and liberating gold in reactive sulphide minerals.

12. A processing plant for recovering gold from a gold-containing ore that contains reactive sulphide minerals, the plant including:
(a) a plurality of ore processing units; and
(b) a control system for controlling at least one of the ore processing units to optimize processing reactive sulphide minerals in the ore to liberate gold in the reactive sulphide minerals in the unit.

13. A processing plant for recovering gold from a gold-containing ore that contains reactive sulphide minerals, the plant including:
(a) an ore preparation unit that includes comminution and size separation units for processing a mined ore and producing an ore preparation unit output from a mined ore,
(b) at least one oxidation unit for oxidizing gold-containing sulphide minerals in the ore;
(c) a metal recovery unit for recovering gold from the oxidation unit output of at least one oxidation unit; and
(d) a control system for controlling the oxidation unit to oxidise at least substantially all of the sulphur in the reactive sulphide minerals in the ore and liberate gold in the reactive sulphide minerals and not preferentially oxidize sulphur in barren sulphide minerals in the ore to thereby optimize downstream recovery of gold a discharge stream from the oxidation unit in the metal recovery unit.

14. A processing plant for recovering gold from a gold-containing ore that contains reactive sulphide minerals, the plant including:
(a) an ore preparation unit that includes comminution and size separation units for processing a mined ore and producing an ore preparation unit output from a mined ore,
(b) a sulphide concentration unit for producing a concentrate output from at least a part of the ore preparation unit output;
(c) at least one oxidation unit for oxidizing sulphur in gold-containing sulphide minerals in the ore;
(d) a metal recovery unit for recovering gold from the oxidation unit output of at least one oxidation unit and/or concentrate output from the sulphide concentration unit; and
(e) a control system for controlling operation of one or both of the oxidation unit and the metal recovery unit, the control system being operable to control the operation of the oxidation unit and/or the metal recovery unit to optimize recovery of gold from the reactive sulphide minerals.
